(19) United States
(12) Patent Application Publication
(10) Pub. No.: US 2025/0315319 A1
(43) Pub. Date: Oct. 9, 2025

(54) ASYNCHRONOUS POST-SEND

(71) Applicant: NVIDIA Corporation, Santa Clara, CA (US)

(72) Inventors: Pak Markthub, Tokyo (JP); Daniel Marcovitch, Yokneam (IL); Sreeram Potluri, Milpitas, CA (US)

(21) Appl. No.: 18/630,410

(22) Filed: Apr. 9, 2024

(51) Int. Cl. G06F 9/54

(52) U.S. Cl. CPC G06F 9/542

(57) ABSTRACT

A system is described having one or more processing devices that execute a requestor thread and a doorbell ringing thread. The requestor thread includes receiving a prompt from an application, in response to the prompt, generating a work queue entry (WQE), and after generating the WQE, atomically incrementing a first counter. The doorbell ringing thread includes monitoring a value of a first index, detecting a change in the value of the first index, in response to the change in the value of the first index, generating a control (ctrl) segment using at least one of the value of the first index and a queue number, and ringing a doorbell (DB) by writing the ctrl segment to a control address.

### FIELD OF THE DISCLOSURE

The present disclosure is generally directed to systems, methods, and devices for transmitting data between nodes and, in particular, toward improving kernel-initiated communications.

### BACKGROUND

In modern high-performance computing (HPC) systems, communication between computing devices is typically facilitated by a network of interconnected nodes. Each computing device, which may contain a central processing unit (CPU), a graphics processing unit (GPU), and/or other hardware peripheral device, can be considered a node in the network. Data is transmitted between such nodes in a series of discrete operations, with each node serving as a relay point for the data. This structure enables parallel processing and data sharing, significantly improving overall system performance and enabling complex computational tasks. Communication between nodes is governed by various protocols, which can vary depending on the specific requirements of the system and the type of devices involved.

The concept of queue pairs (QPs) supports efficient operation of these inter-network communications. A QP is composed of a work queue including a send queue and a receive queue, acting as endpoints for data transmission between nodes. The send queue holds instructions for outgoing data, while the receive queue accommodates incoming data instructions. QPs also require completion queues which signal the completion of work requests posted to the work queue. The use of QPs enables network technologies such as InfiniBand to provide high-speed, low-latency communication between nodes. The implementation and management of QPs, however, can be complex, necessitating detailed handling of data transmission protocols and error management.

Latency and memory consumption are key factors in the performance and efficiency of these communication networks. Latency refers to the delay experienced during data transmission between nodes, which can impact the overall performance in real-time or high-speed applications. Memory consumption on the other hand relates to the amount of memory resources utilized for data transmission and processing. High memory consumption can lead to inefficiencies, potentially slowing down other processes and limiting the overall system performance. Optimizing both latency and memory consumption is therefore a continuous challenge in the development and operation of high-performance computing systems. Various strategies and technologies are employed to tackle these issues, aiming to deliver fast, efficient, and reliable communication between devices.

Technical shortcomings of conventional computing system networks relating to memory consumption and latency negatively affect real-world applications involving, for example, artificial intelligence models, mathematical calculations, and other computationally complex applications.

### SUMMARY

In some communication protocols, such as an MLX5 post-send protocol, work queue entry (WQE) submission involves enqueueing a WQE into a ring buffer and updating the head pointer to submit work to a peripheral device, such as a network interface card (NIC) or similar type of Input/Output (IO) device. In particular, a post-send protocol may include: (1) writing the WQE (or WQEs) in a work queue (WQ) buffer; (2) updating the doorbell record (DBR); and ringing the doorbell (DB).

In the GPUDirect Async—Kernel Initiated networking protocol (GDA-KI), WQ and DBR are in GPU memory. The DB is usually provided on the NIC. In CPU-centric libraries such as libibverbs, WQ and DBR are in host memory and the DB is on the NIC.

This is an inherently sequential process as it was designed for use by CPUs. Communication protocols such as GDA-KI, which utilize GPUs instead of CPUs, leverage a GPU streaming multiprocessor (SM) to submit WQEs to the NIC. If traditional WQE submission algorithms are strictly followed, the GPU will need to (1) lock the network QP, which limits the concurrency, or (2) create one QP per thread, which may consume hundreds GB of GPU memory in real applications. In addition, each WQE submission will require issuing a memory barrier, which incurs significant latency for the GPU SMs.

Embodiments of the present disclosure are contemplated for use in an architecture having a scalable array of multithreaded SMs. Each SM may include a set of execution units, a set of registers, and a chunk of shared memory. In some embodiments, the basic unit of execution for a processing unit (e.g., a CPU or GPU) may be referred to as a warp. A warp may correspond to a collection of threads (e.g., 32 threads may belong to a warp) that are executed simultaneously by an SM. Multiple warps can be executed on an SM at once.

In some embodiments, a compute thread array (CTA), which may be referred to as a thread block, may correspond to a group of threads that can cooperate by sharing data through shared memory and synchronizing their execution. A CTA may be executed by one or more SMs, and multiple CTAs may run in parallel across different SMs. Each CTA may have access to a shared memory space that is visible to all threads within the CTA, allowing for efficient communication and data sharing between the threads of the CTA.

A kernel grid as referred to herein may be a set of threads which are launched by a single kernel. The threads of a kernel grid may be grouped into CTAs, allowing the threads to share resources and synchronize execution. When a program on a host CPU invokes a kernel grid, CTAs of the grid may be enumerated and distributed to SMs with available execution capacity. The threads of a CTA may execute concurrently on one SM, and multiple CTAs can execute concurrently on one SM. As CTAs terminate, new CTAs may be launched on the vacated SMs.

A CTA may include one or more warps of threads. As an example, a CTA may include 128 threads, and the threads may be divided into four warps of 32 threads per warp. Each warp may be scheduled and executed independently, whether in parallel or in sequence.

Embodiments of the present disclosure aim to improve communication efficiencies by increasing the parallelism of the DB ringing process described above. Embodiments of the present disclosure further contemplate improving communication efficiencies while working within the framework of existing post-send protocol(s). Aspects of the present disclosure may include two phases: a requesting thread and a DB ringing thread.

While embodiments of the present disclosure will be described in connection with an architecture having a scalable array of multithreaded SMs, it should be appreciated that features depicted and described herein can be utilized in other architectures. Specifically, but without limitation, embodiments of the present disclosure can be deployed in any computing architecture in which threads issue WQE slot reservation and/or WQE creation instructions/requests.

One aspect of the present disclosure is to reduce the amount of time required to ring the DB following data being written by an application. This approach involves utilizing a requesting thread and a DB ringing thread. The requesting thread and the DB ringing thread may be performed by a single warp, different warps of a CTA, different CTAs, and/or different devices, such as by using a GPU to perform the requesting thread and a CPU to perform the DB ringing thread.

An advantage of the systems and methods described herein is enabling steps of the DB ringing process to be performed in parallel. While contemporary methods of ringing the DB may require two or more memory barriers in sequence, the methods described herein may be implemented by performing two memory barriers in parallel, thereby cutting the required amount of time consumed by performing the memory barriers in half.

In view of the above, one or more of the following are contemplated:

One aspect of the present disclosure is to provide a system comprising one or more circuits to monitor a value of a first index; detect a change in the value of the first index; generate a control (ctrl) segment using at least one of the value of the first index and a queue number; and write the ctrl segment to a control address.

In some embodiments, the one or more circuits further: receive a prompt from an application; in response to the prompt, generate a work queue entry (WQE); and after generating the WQE, atomically increment a first counter, wherein writing the ctrl segment to the control address causes the WQE to be read by a peripheral device.

In some embodiments, one warp of a cooperative thread array (CTA): monitors the value, detects the change, generates the ctrl segment, and writes the ctrl segment to the control address; and another warp of the CTA: receives the prompt, generates the WQE, and increments the first counter.

In some embodiments, one cooperative thread array (CTA): monitors the value, detects the change, generates the ctrl segment, and writes the ctrl segment to the control address; and another CTA: receives the prompt, generates the WQE, and increments the first counter.

In some embodiments, the one or more circuits include: a central processing unit (CPU) to: monitor the value, detect the change, write the ctrl segment to the control address; and a graphics processing unit (GPU) to: receive the prompt, generate the WQE, and increment the first counter.

In some embodiments, the one or more circuits include: a data-path accelerator (DPA) to: monitor the value, detect the change, write the ctrl segment to the control address; and a graphics processing unit (GPU) to: receive the prompt, generate the WQE, and increment the first counter.

In some embodiments, a single thread: monitors the value, detects the change, generates the ctrl segment, writes the ctrl segment to the control address, receives the prompt, generates the WQE, and increments the first counter.

In some embodiments, monitoring the value, detecting the change, generating the ctrl segment, and writing the ctrl segment to the control address are performed in parallel with receiving the prompt, generating the WQE, and incrementing the first counter.

In some embodiments, detecting a change in the value of the first index comprises determining the value of the first index is greater than a value of a second index.

In some embodiments, the one or more circuits are further to set the value of the second index equal to the value of the first index after writing the ctrl segment to the control address.

In some embodiments, the one or more circuits are further to update a doorbell record (DBR) with the value of the first index in response to the change in the value of the first index.

In some embodiments, the one or more circuits are further to push the DBR to a cache of a graphics processing unit (GPU).

Another aspect of the present disclosure is to provide a device, comprising one or more circuits to execute: a first thread to: monitor a value of a first index; detect a change in the value of the first index; generate a control (ctrl) segment using at least one of the value of the first index and a queue number; and write the ctrl segment to a control address; and a second thread to: receive a prompt from an application; in response to the prompt, generate a work queue entry (WQE); and after generating the WQE, atomically increment a first counter, wherein ringing the DB causes the WQE to be read by a peripheral device.

In some embodiments, one warp of a cooperative thread array (CTA) executes the first thread; and another warp of the CTA executes the second thread.

In some embodiments, one cooperative thread array (CTA) executes the first thread; and another CTA executes the second thread.

In some embodiments, the one or more circuits include: a central processing unit (CPU) to execute the first thread; and a graphics processing unit (GPU) to execute the second thread.

In some embodiments, the one or more circuits include: a data-path accelerator (DPA) to execute the first thread; and a graphics processing unit (GPU) to execute the second thread.

In some embodiments, the first and second threads are performed in parallel.

In some embodiments, detecting a change in the value of the first index comprises determining the value of the first index is greater than a value of a second index.

Another aspect of the present disclosure is to provide a method of ringing a doorbell (DB), the method comprising: monitoring a value of a first index; detecting a change in the value of the first index; generating a control (ctrl) segment using at least one of the value of the first index and a queue number; and writing the ctrl segment to a control address.

Additional features and advantages are described herein and will be apparent from the following Description and the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

The present disclosure is described in conjunction with the appended figures, which are not necessarily drawn to scale:

FIG. 1 is a block diagram of a computing architecture used in accordance with one or more of the embodiments described herein;

FIG. 2 is a block diagram of a system in accordance with one or more of the embodiments described herein;

FIG. 3 is a block diagram of system components and interactions therebetween in accordance with one or more of the embodiments described herein;

FIG. 4 is a block diagram of a control segment in accordance with one or more of the embodiments described herein;

FIG. 5 is a flow diagram illustrating a first method in accordance with one or more of the embodiments described herein; and

FIG. 6 is a flow diagram illustrating a second method in accordance with one or more oof the embodiments described herein.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The details of one or more aspects of the disclosure are set forth in the accompanying drawings and the description below. Other features, objects, and advantages of the techniques described in this disclosure will be apparent from the description and drawings, and from the claims.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It will be appreciated from the following description, and for reasons of computational efficiency, that the components of the system can be arranged at any appropriate location within a distributed network of components without impacting the operation of the system.

Further, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Any of the steps, functions, and operations discussed herein can be performed continuously and automatically.

Systems and methods of this disclosure may be described in relation to a network of switches; however, to avoid unnecessarily obscuring the present disclosure, the description may omit a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

Conventional computer systems employing both one or more CPUs as well as one or more GPUs typically utilize a star topology, positioning the CPU at the centerpiece of the communication between components of the computer system. In such a system, the CPU(s) act as a central hub through which data flows, including communications between the GPU and various peripheral devices such as network devices, additional GPUs, NVMe solid state drives (SSDs), and other components. This means that for a GPU to access data from, or send data to, such peripheral devices, the GPU must do so via the CPU, relying on the CPU to manage and facilitate data transfers. Such an architecture can introduce bottlenecks, as communications are funneled through the CPU. Consequently, the efficiency of data transfer and overall system performance can be contingent on the CPU's capacity to handle the data streams, and a GPUs ability to communicate with peripheral devices is limited by the performance of the CPU.

Direct communication between GPUs and peripheral devices, without involving a CPU, can significantly enhance system performance and efficiency in various computing environments. This approach offers several benefits, particularly in high-performance computing (HPC), data centers, and AI or machine learning applications, where speed and efficient data handling are critical.

Bypassing the CPU for communication between GPUs and peripheral devices can drastically reduce latency. While conventional systems, as described above, rely on a CPU acting as a mediator, direct GPU-to-peripheral device communication eliminates the involvement of the CPU, allowing for quicker data exchanges.

Direct paths between GPUs and peripheral devices can utilize the full bandwidth of the interconnect technology (such as PCIe), without sharing or competing for bandwidth with the CPU or other devices on an interconnect bus of the CPU. Moreover, applications such as AI and machine learning can be improved by quickly offloading data processed by the GPU to storage devices (such as NVMe SSDs) or sent over a network to other nodes for further processing. Direct GPU-to-peripheral device communication streamlines such workflows, enabling more efficient data processing pipelines without the CPU becoming a bottleneck.

Offloading communication tasks from the CPU further frees up resources of the CPU for other critical tasks. This may be particularly beneficial in systems where the CPU manages multiple tasks simultaneously. Reducing the communication overhead of the CPU can lead to overall improvements in system performance and responsiveness.

Direct communication by GPUs also supports better parallelism in system architectures. GPUs designed for parallel processing can simultaneously interact with multiple peripheral devices, enhancing the system's ability to handle concurrent data streams and parallel processing tasks.

Direct GPU-to-peripheral device communication may be enabled through technologies such as GPUDirect Asyc—Kernel-Initiated (GDA-KI) which allows GPUs to directly access data from NVMe SSDs, NICs, and other peripheral devices. While certain implementations described herein relate to GDA-KI and communications between a GPU and a NIC, it should be appreciated that the systems and methods described herein may be used to enable communication between any processing device (e.g., a CPU, GPU, DPA, etc.) and any peripheral device (e.g., a CPU, a GPU, a DPA, a NIC, a memory device such as an NVMe SSD, etc.).

The use of GPUs as a means to offload computationally intensive tasks from CPUs and the use of networks of computing nodes to implement computationally intensive tasks, whether executed by CPUs or GPUs, is increasingly important to users such as scientific researchers seeking to execute artificial intelligence (AI) models and other computationally intensive processes. The growing demand for high-performance computing in various domains, including scientific simulations, machine learning, and image processing, has driven the need for efficient and cost-effective computational resources. The limitations of network communication performance and the increasing importance of parallelism have prompted researchers and other users to explore alternatives to the use of single computing devices for performing data processing. As a result, GPUs have emerged as an approach to offload computationally intensive tasks from CPUs and networks of computing systems have become useful for executing complex processing applications.

In conventional systems, whenever a GPU needs to send data to a node, a CPU is notified. The CPU then prepares a WQE, updates a DBR on a NIC, and rings the DB. Next, the NIC may access the data from memory of the GPU to send to the node. For example, in some implementations GPUDirect RDMA may be used so that the NIC and the GPU can communicate directly; however, the control path flows through the CPU. It should be appreciated that in some implementations other technologies enabling a NIC to access data from GPU memory may be utilized.

GPUDirect Async—Kernel Initiated (GDA-KI) is a network software technology which moves the control path onto the GPU, using SMs of the GPU to prepare WQEs, write to the DBR, and ring the DB. As a result, the message rate that can be achieved by a GPU increases by several folds (e.g., up to 36× as compared to conventional systems). Embodiments of the present disclosure are useful when the GPU is interacting with any I/O device that employs a similar command submission mechanism like the NIC mechanism(s) described herein.

GDA-KI presents a number of challenges to enable a GPU to communicate with a NIC. In some systems, an edit to a registry key (regkey) may be required to enable an SM of a GPU to ring the DB. Because such a regkey, e.g., PeerMappingOverride, may be required to be edited to enable the GPU to communicate with the NIC, adoption of the GDA-KI may be slow and many users, such as end users without administrator privileges, may be prevented from benefiting from GDA-KI. Even users with the ability to edit the regkey to enable GDA-KI may be hesitant to make the edit due to potential security risks.

Another challenge is that the GDA-KI post-send algorithm has a high latency from the perspective of the GPU caller thread. This problem is undesirable for applications because the caller threads are blocked while waiting for the post-send API call to return. In NVSHMEM, this results in a delay in starting useful computation of the threads.

The systems and methods described herein may be used by computing systems in which a GPU communicates with GPUs of peers, such as through NVSHMEM or other GPU-accelerated libraries, without requiring the editing of a regkey and without the excessive latency of the GDA-KI post-send algorithm. Embodiments of the present disclosure may include a GPU performing data packet preparation, scheduling, sending or transmission. Through such a system, workloads may be shifted from a CPU to computationally viable GPUs.

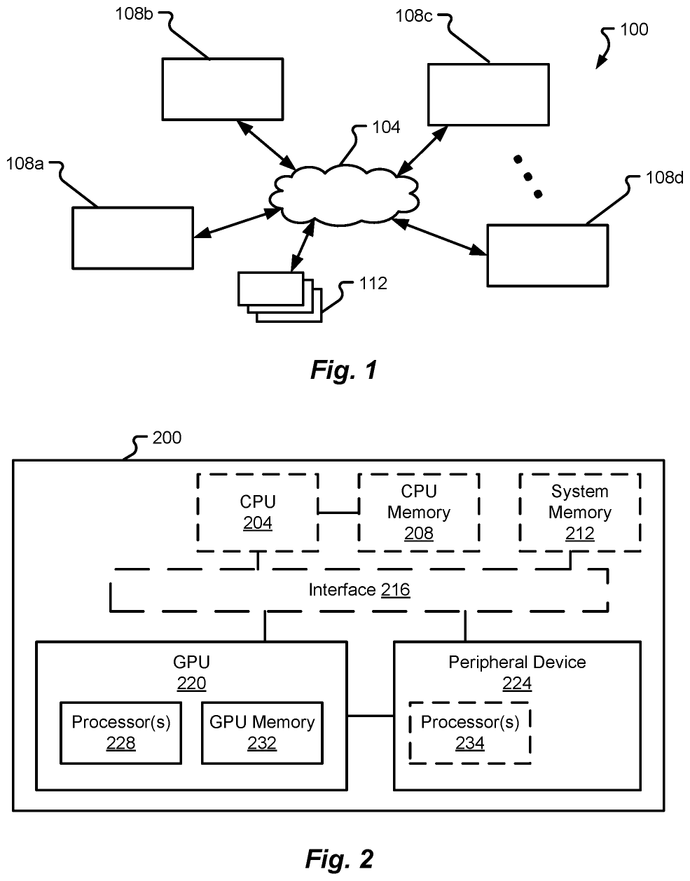

Reference is now made to FIGS. 1 and 2, in which a computing architecture 100 and system 200 are illustrated in accordance with one or more embodiments. The computing architecture 100 may include one or more peer computing systems 108a-d communicating with each other via a network 104.

Each of the one or more peer computing systems 108a-d may connect to each other as well as to other peer devices 112 to access shared resources, services, and data, via the network 104. The peer computing systems 108a-d may be, for example, client devices such as personal computers, laptops, smartphones, IoT devices, as well as switches or servers, or any type of computing system capable of sending data to and receiving data over a network 104.

Each of the peer devices 112 may comprise network interfaces including, for example, a transceiver. Some or all of the peer devices 112 may be capable of receiving and transmitting packets in conformance with applicable protocols such as TCP, although other protocols may be used. Peer devices 112 may also be configured to receive and transmit packets to and from network 104.

In some implementations, one or more peer computing systems 108a-d and devices 112 may be switches, proxies, gateways, load balancers, etc. Such systems 108a-d and devices 112 may serve as intermediaries between clients and/or servers, relaying or modifying the communication between the clients and/or servers.

In some implementations, one or more of the peer computing systems 108a-d and devices 112 may be IoT devices, such as sensors, actuators, and/or embedded systems, connected to the networks 104. Such IoT devices may act as clients, servers, or both, depending on implementations and the specific IoT applications. For example, a first peer computing system or device may be a smart thermostat acting as a client, while a second peer computing system or device may be a central server for analysis or a smartphone executing an app.

As should be appreciated, in the realm of high-performance computing, a myriad of peer computing systems 108a-d can utilize QPs and WQ buffers for network communication. For example, in server farms, data centers, or clusters used for big data analytics and scientific computing, CPUs and/or GPUs of a peer computing system 108a-d may use QPs and WQ buffers to send and receive data between each other, such as via protocols including InfiniBand or Ethernet.

A system 200 having one or more GPUs 220 may correspond to an example of a peer computing system 108a-d and/or a peer device 112. The advent of general-purpose computing on GPU has led to widespread use of GPUs 220 for tasks beyond just rendering graphics, especially in fields like machine learning, deep learning, and data mining. GPUs 220 may be capable of handling thousands of threads simultaneously, making them well-suited for massively parallel tasks.

While the system 200 may be configured to communicate with other systems 200 over the network 104 as described herein, it should be appreciated that the systems 200 may also communicate with other peer computing systems 108a-d and/or peer devices 112, which may or may not utilize the network 104.

The network 104 illustrated in FIG. 1 may rely on various networking hardware and protocols to establish communication between a peer computing system 108a-d and other peer computing systems 108a-d and/or peer devices 112. Such infrastructure may include one or more routers, switches, and/or access points, as well as wired and/or wireless connections. The network 104 may be, for example, a local area network (LAN) interconnecting peer computing systems 108a-d and peer devices 112. A LAN may use Ethernet or Wi-Fi technologies to provide communication between the peer computing systems.

In some implementations, the network 104 may be, for example, a wide area network (WAN) and may be used to connect peer computing devices 112 with one or more peer computing systems 108a-d. A WAN may comprise, for example, one or more of lines, satellite links, cellular networks. WANs may use various transmission technologies, such as leased lines, satellite links, or cellular networks, to provide long-distance communication. Transmission control protocol (TCP) communication over a WAN may be used, for example, to enable peer computing systems 108a-d to communicate reliably across vast distances. In some implementations, network 104 may comprise the Internet, one or more mobile networks, such as 4G, 5G, LTE, virtual networks, such as a VPN, or some combination thereof.

System 200, like the peer computing systems 108a-d, may be or include client devices and may encompass a wide range of devices, including desktop computers, laptops, smartphones, IoT devices, etc. Such systems 200 may execute one or more applications which communicate with other systems 200 to access resources or services. For example, a first system 200 may execute a web browser and a second system 200 may act as a web server. The first computing system 200 may communicate with the second system 200 to request and display web content. As another example, a first system 200 may execute a file-sharing application and a second system 200 may act as a file server. The first system 200 may communicate with the second system 200 to upload or download files. As another example, a first system 200 may act as an AI server capable of being used by a second system 200 to offload computationally intensive processes for execution in parallel by one or more GPUs 220 of the first system 200. Applications running on the systems 200 may be responsible for initiating communication with other systems 200 making requests for resources or services, and processing data. The network 104 may enable the systems 200 to communicate any number of concurrent communications with any number of peer computing systems 108a-d and/or peer devices 112 simultaneously.

It should also be appreciated that in some embodiments, the systems and methods described herein may be executed without a network 104 connection. For example, one or more peer computing systems 108a-d (or systems 200) may be capable of communicating directly with other peer computing systems 108a-d (or systems 200) without relying on any particular network 104.

As illustrated in FIG. 2, each a system 200 may include one or more one or more GPUs 220 and one or more peripheral devices 224. In some implementations, each system 200 may also include one or more CPUs 204. Each of the CPUs 204, GPUs 220, and peripheral devices 224 may communicate via an interface 216.

A peripheral device 224 as described herein may comprise one or more circuits capable of acting as an interface between components of the system 200, such as the CPU 204 and the GPU 220. The peripheral device 224 may also act as an interface between components of the system 200 and the network 104. A peripheral device 224 may, for example, comprise a NIC; however, the systems and methods described herein may be applied to any type of peripheral device, such as a GPU, a CPU, a memory device such as an NVMe SSD, or another component. In the case of a NIC, the peripheral device 224 may enable data transmission and reception such that peer computing systems 108a-d may communicate with the system 200. In other implementations, a peripheral device 224 may perform other functions. A peripheral device 224 may in some implementations comprise one or more of a peripheral component interconnect express (PCIe) card, a network adapter, a USB adapter, and/or may be integrated into a PCB such as a motherboard. The peripheral device 224 may also include one or more processors 234. A processor 234 of a peripheral device 224 may be, for example, a streaming multiprocessor (SM), a RISC processor, a CISC processor, a DSP, a baseband processor, an ASIC, an FPGA, an RFIC, another processor (including those discussed herein), or any suitable combination thereof. The peripheral device 224 may be capable of supporting any number of network protocols such as Ethernet, Wi-Fi, fiber channel, etc.

As described herein, the peripheral device 224 may be capable of receiving packets from one or more peer computing systems 108a-d via the network 104. The peripheral device 224 may process a header of each received packet to determine whether each packet should be handled by the CPU 204 or the GPU 220. In some implementations, the NIC 224 may be in direct communication with each of the GPU(s) 220 and the CPU(s) 204 via the interface 216 as well as in external communication with the network 104 via, for example, Ethernet in combination with TCP.

One or more CPUs 204 of the system 200 may each comprise one or more circuits capable of executing instructions and performing calculations. The CPUs 204 may be capable of interpreting and processing data received by the system 200 via the peripheral device 224. CPUs 204 of a system 200 may each comprise one or more arithmetic logic units (ALUs) capable of performing arithmetic and/or logical operations, such as addition, subtraction, and bitwise operations. The CPUs 204 may also or alternatively comprise one or more control unit (CUs) which may be capable of managing the flow of instructions and data within the CPU 204. CUs of the CPU 204 may be configured to fetch instructions from CPU memory 208 or system memory 212, decode the instructions, and direct appropriate components to execute operations based on the instructions.

A CPU 204 of the system 200 may include, for example, a reduced instruction set computing (RISC) processor, a complex instruction set computing (CISC) processor, a digital signal processor (DSP) such as a baseband processor, an application-specific integrated circuit (ASIC), a field-programmable gate array (FPGA), a radio-frequency integrated circuit (RFIC), another processor (including those discussed herein), or any suitable combination thereof. Similarly, a GPU 220 as described herein may include a processor 228 such as an SM, a RISC processor, a CISC processor, a DSP, a baseband processor, an ASIC, an FPGA, an RFIC, another processor (including those discussed herein), or any suitable combination thereof.

A CPU 204 and/or a processor 228 of a GPU 220 as described herein may incorporate multiple processing cores, allowing the CPU 204 (and/or the GPU 220) to execute multiple instructions simultaneously, and/or may be capable of performing hyperthreading to execute multiple threads concurrently.

One or more GPUs 220 of the system 200 may each comprise one or more circuits capable of acting as specialized processing components to handle computationally intensive tasks, such as rendering graphics and performing complex mathematical calculations. GPUs 220 may be capable of parallel execution of general-purpose tasks alongside the CPUs 204.

As noted above, a GPU 220 may comprise one or more SMs, CUs, or processors 228, which may be responsible for executing instructions in parallel. Each SM, CU, or processor 228 of a GPU 220 may contain one or more processing cores or ALUs which may be capable of performing arithmetic and/or logical operations concurrently.

One, some, or all GPUs 220 of the system 200 may be capable of executing tasks such as scientific simulations, machine learning, and data analysis. For example, a GPU 220 of the system 200 may be designed for operation in workstation environments, such as for performing scientific simulations, executing and/or training machine learning models, performing data analysis, etc.

The GPU 220 may execute one or more kernels. Kernels executed by the GPU 220 may perform specific, parallelizable tasks on the GPU 220. Such kernels may be written using GPU programming languages or frameworks, such as CUDA.

The interface 216 of the system 200 may comprise one or more circuits capable of connecting peripheral devices such as the peripheral device 224, one or more GPUs 220, and one or more CPUs 204 to a motherboard of the system 200, as well as one or more devices used for system memory 212. The interface 216 may comprise one or more high-speed lanes. Each lane may be, for example, a serial lane, and may consist of a pair of signaling wires for transmitting and/or receiving data. The interface 216 may be, for example, a PCIe bus.

The device(s) used for system memory 212 may include solid-state drives (SSDs), such as NVMe SSDs. The system memory 212 may be capable of providing fast and efficient data access and storage. Each of the CPU 204, GPU 220, and peripheral device 224 may be capable of sending data to and reading data from the system memory 212 via the interface 216. Each of the CPU 204, GPU 220, and peripheral device 224. Illustratively, but without limitation, the CPU 204 may have access to dedicated CPU memory 208 and the GPU 220 may have one or more devices dedicated to GPU memory 232.

The disclosed systems and methods may be adaptable and usable for both systems with and without GPUs 220. As described above, embodiments of the present disclosure may include a GPU 220 performing data packet preparation, scheduling, sending, and/or transmission. In some embodiments, the CPU 204 may instruct the GPU 220 (or multiple GPUs 220) to perform various tasks. Such platforms may employ GPU accelerated signal processing, such as by using GDA-KI to enable the GPU 220 to prepare network work descriptors or WQEs and submit such descriptors to the peripheral device 224.

Because the CPU 204 and GPU 220 may have different memory spaces, data that is processed by the GPU 220 is moved from the CPU 204 to the GPU 220 before the computation starts, and the results of the computation are moved back to the CPU 204 once processing has completed. The system memory 212, on the other hand, represents global memory that is accessible to all threads as well as the host (e.g., the CPU 204). Global memory may be allocated and deallocated by the host and may be used to initialize the data that the GPU 220 will work on.

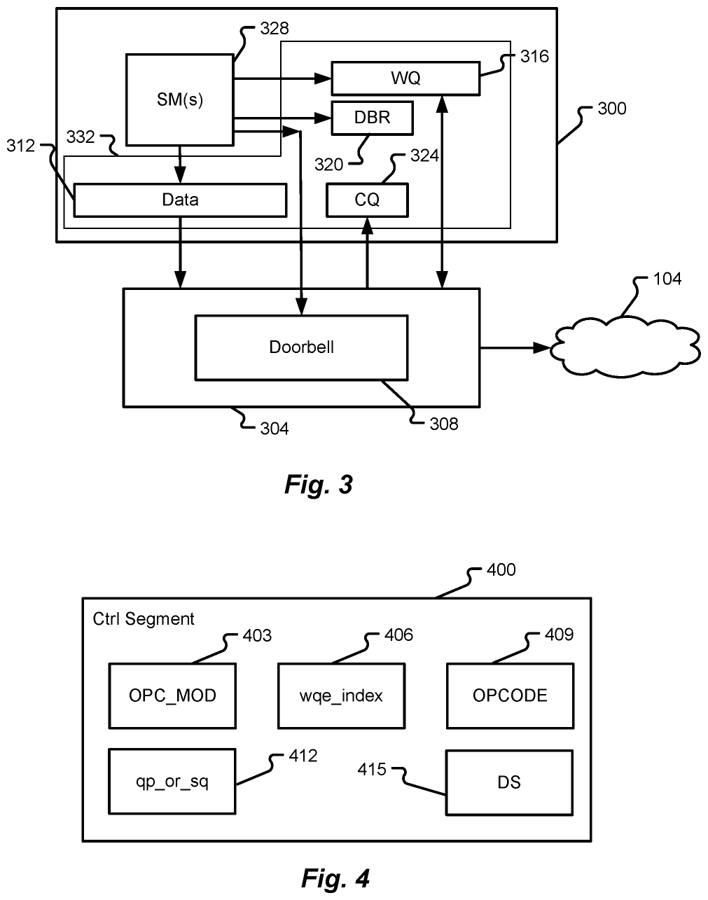

Referring now to FIG. 3, additional details of a processing unit 300 interacting with a peripheral device 304 will be described in accordance with at least some embodiments of the present disclosure. A CPU 204 and/or GPU 220 may correspond to examples of a processing unit 300. Other examples of a processing unit 300 include, without limitation, a DPA, a DPU, a microprocessor, a collection of CPUs 204, a collection of GPUs 220, a collection of DPUs, a collection of microprocessors, and the like.

A peripheral device 224 may correspond to an example of a peripheral device 304. It should be appreciated that embodiments of the present disclosure may apply to other queue-based producer-consumer models, such as the NVMe submission queue. In this context, a peripheral device 304 may correspond to a different type of device, such as a memory device.

The processing unit 300 is illustrated to include one or more SMs 328. Within the context of the processing unit 300, the basic unit of execution may be referred to as a warp. A warp, as described above, is a collection of threads that are executed simultaneously by an SM 328. Multiple warps can be executed by an SM 328 at once.

When a program on the processing unit 300 invokes a kernel grid, CTAs of the grid are enumerated and distributed to one or more SMs 328 with available execution capacity. The threads of a CTA execute concurrently on one SM 328, and multiple CTAs can execute concurrently on one SM 328. As CTAs terminate, new CTAs may be launched on the vacated SMs 328.

Applications executed by an SM 328 of the processing unit 300 may write data 312 to memory 332. When data 312 needs to be transmitted to a destination, the processing unit 300 may transfer the data 312 to the peripheral device 304 and/or receive data 312 from the peripheral device 304 using a WQ 316, a DBR 320, and a completion queue (CQ) 324. Each of the WQ 316, DBR 320, and CQ 324 may comprise one or more buffers or logical storage units within the memory 332. The WQ 316, DBR 320, and CQ 324 may enable the SMs 328 of the processing unit 300 to interact directly with the peripheral device 304.

WQs 316 may hold WQEs, which represent operations to be performed. The WQ 316 may operate as a repository for WQEs. Each WQE in a WQ 316 may contain information about the operation such as the type of operation, the location of the data, and other control information. Thus, each WQ 316 consumes memory for every WQE it holds, impacting the overall memory consumption of a QP.

The information contained within a WQE may include a ctrl segment 400 as illustrated in FIG. 4 as well as other information, such as a data segment. A ctrl segment 400 of a WQE may include, for example, an operation code modifier (OPC_MOD) 403, a WQE index (wqe_index or producer index) 406, an operation code (OPCODE) 409, a queue number or a send queue identifier (qp_or_sq) 412, a data segment length (DS) 415, and/or other information.

Conventionally, when a DB is to be rung, whether by a CPU or a GPU, the entire ctrl segment is written to the DB of the peripheral device 304. This includes each of the OPC_MOD 403, wqe_index 406, OPCODE 409, qp_or_sq 412, and DS 415. Because the ctrl segment is inside the WQE, the thread which prepared the WQE is conventionally used to ring the DB or shares the WQE with another thread which rings the DB. However, using a single thread to prepare the WQE and ring the DB requires performing multiple memory barriers in sequence and as a result costs an excessive amount of time. Sharing the WQE with another thread is computationally expensive and impractical.

As described herein, instead of sharing the entire WQE with another thread to ring the DB, the DB can be rung by another thread with access to only the qp_or_sq and the producer index. Other contents of the ctrl segment can be set to zero. As described herein, the producer index may be incremented in software using an atomic operation which is relatively efficient and makes sharing the producer index across threads relatively simple.

CQs 324 may be utilized to track a completion status of WQEs. When an operation associated with a WQE is completed, a completion event may be generated and placed into a CQ 324. A QP may be associated with one or more CQs 324. Therefore, for each QP, memory may be consumed for the storage of completion events within these CQs 324.

DBRs 320 may be used as a notification mechanism when new WQEs are put on the WQs 316 or to solicit completion notifications from the CQs 324. Each QP may be associated with a corresponding DBR.

The memory and/or storage devices of the system 200 may store instructions such as software, a program, an application, or other executable code for causing at least any of the CPU 204, the GPU 220, and the peripheral device 224 to perform, alone or in combination, any one or more of the methods described herein. The instructions may in some implementations reside, completely or partially, within at least one of the memory/storage devices illustrated in FIGS. 1-3, or any suitable combination thereof.

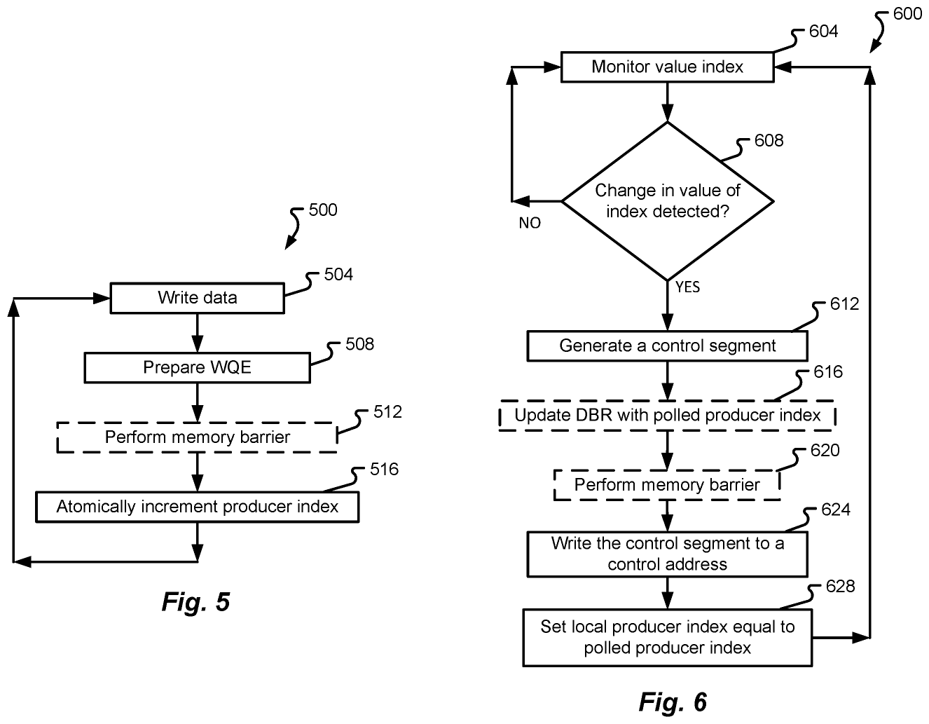

In some embodiments, the electronic device(s), network(s), system(s), chip(s), circuit(s), or component(s), or portions or implementations thereof, of FIGS. 1-3, or some other figure herein, may be configured to perform one or more processes, techniques, or methods as described herein, or portions thereof. Such processes may be as depicted in FIGS. 5 and 6 and as described below.

In operation, the processing unit 300 may interact with the peripheral device 304 according to a series of operations as illustrated by the methods 500, 600 of FIGS. 5 and 6. The operations may be performed by two separate threads, a requestor thread and a DB ringing thread. The requestor thread and the DB ringing thread enable an asynchronous post-send method. Traditionally, the creation of the WQE and the ringing of the DB are performed by a single thread. By separating the requesting phase and the DB ringing phase onto separate threads, the DB ringing can be performed much faster as compared to conventional methods.

As described in greater detail below, the requestor thread and the DB ringing thread can be executed by different threads, different warps, different CTAs, or even different processors. The requestor thread may be executed by an SM of a GPU, such as a CUDA thread, or may be run on a CPU, an FPGA, or other processing device.

While examples provided herein refer to the use of GDA-KI, it should be appreciated that the same or similar methods may be utilized for CPU-based post-send, enabling asynchronous post-send for CPUs.

The requestor thread is illustrated by the method 500 of FIG. 5. In a first operation, an application launches a kernel that writes data 312, at 504, in memory 332 of the processing unit 300. The memory of the processing unit may include CPU memory 208, GPU memory 232, and/or system memory 212, for example.

In response to the data 312 written in the memory 332 of the processing unit 300, the application may call an operation (e.g., nvshmem_put) to communicate with another device (e.g., a peer computing system 108a-d, a peer device 112, peripheral device 304, etc.). In this step, an SM 328 may be used to create a WQE or work descriptor. The WQE may be written directly to a WQ 316. As mentioned above, a WQ 316 may reside directly on memory of the processing unit 300 (e.g., as CPU memory 208 and/or GPU memory 232). In some embodiments, this operation may be viewed as an operation in which one or a plurality of WQEs are created.

Next, the SM 328 may perform a memory barrier at 512. As noted above, the WQ 316 may be on the memory 332 of the processing unit 300. Depending on the location of the processor performing the DB ringing thread, described below in relation to the method 600 of FIG. 6, this memory barrier at 512 may be necessary to flush the WQE prepared at 508 to memory which can be read by the peripheral device 304. The memory barrier at 512 may be used to ensure the WQE is visible to the peripheral device 304. In some implementations, the memory barrier at 512 may not be required. For example, as described below, if the requestor thread and the DB ringing thread are both executed by a single CTA, such as by different warps on the same CTA, the memory barrier at 512 may not be required, which may decrease the time to completion as compared to performing two memory barriers, though it should be appreciated the memory barrier at 512 and the memory barrier described below at 616 may be performed in parallel, reducing the amount of time as compared to conventional methods of ringing the DB.

A memory barrier as described herein may be referred to as one or more of a membar, threadfence, threadfence block, or other term. A memory barrier may be used to ensure memory operations (including reads and writes) occur in the desired order. When multiple threads or processes execute concurrently, memory operations can appear out of order. This can lead to data inconsistencies, where the outcome of a program incorrectly depends on the timing of threads.

A memory barrier ensures that all global and shared memory writes made by the current thread are visible to all threads in the grid. A memory barrier may also ensure that all memory operations issued before the memory barrier are completed before any subsequent memory operations begin. Such a memory barrier may be used to guarantee correct data handling when performing parallel computations or when resources are shared across different parts of a pipeline.

At 516, after performing the memory barrier, the requestor thread may atomically increment a software producer index. An atomic increment command may be used to increment the value of the producer index without causing race conditions. By using an atomic increment, the increment operation is indivisible such that no other thread or process can observe the operation at an intermediate state, and at the end of the operation, the producer index will have been increased by exactly one unit. The producer index may be stored in memory of a GPU as a counter.

After incrementing the producer index at 516, the method 500 may restart at new data is written at 504. The requestor thread may continue in this regard, repeating the process of preparing a WQE, performing a memory barrier, and incrementing the producer index.

A DB ringing thread in accordance with the embodiments described herein is illustrated by the method 600 of FIG. 6. The DB ringing thread may be executed by a thread in any number of locations. For example, the DB ringing thread may be executed by a different warp on a same CTA as the requestor thread, by different CTAs on a same processing device, or on a different processing device than the requestor thread. While it may also be possible to execute both the requestor thread and the DB ringing thread on a single thread and/or a single warp, in some implementations it may be preferable to execute the requestor thread and the DB ringing thread in parallel to achieve timesaving and efficiency benefits.

When executing the DB ringing thread on a GPU 220, some computing systems may require a regkey edit as described above. Running both the DB ringing thread and the requestor thread on the same CTA may provide some advantages. For example, a faster or cheaper memory barrier may be performed, by eliminating the memory barrier performed at 512 as described above.

The DB ringing thread may in some implementations be executed by a separate CTA from the CTA executing the requestor thread. The CTA executing the DBA ringing thread may be a dedicated CTA or CUDA kernel which runs only the DB ringing thread or may execute other threads.

The DB ringing thread may be executed by a separate processing device from the requestor thread. For example, a processor 228 of a GPU 220 may execute the requestor thread and either another GPU 220, a CPU 204, a DPA, or a FPGA may execute the DB ringing thread, for example. A DPA may be a processor 234 within or near the peripheral device 224. If using a CPU 204, the CPU may use GDRCopy in order to directly access the GPU memory 232 and take a snapshot of all producer index values from GPU memory 232. By performing the requestor thread by the GPU 220 and the DB ringing thread by a device outside the GPU, the regkey edit described above may not be required, which may increase the adoption rate of GDA-KI.

The DB ringing thread may begin at 604 by monitoring a value of an index. Monitoring the value of the index may in some implementations comprise polling the producer index. The producer index may be a value stored in memory 232 of a GPU 220. As described above, the producer index may be atomically incremented during the requestor thread. If the DB ringing thread is performed by a processor 228 of the GPU 220, the GPU 220 may directly access the producer index. If the DB ringing thread is performed by another device, such as a CPU 204, the device may use GDRCopy of other means to access the GPU memory 232.

At 608, a determination may be made as to whether a change in the monitored value of the index has occurred. For example, the polled value of the producer index may be compared to a local producer index. If the polled value of the producer index is not greater than the local producer index, the DB ringing thread may continue polling the producer index at 604. If the polled value of the producer index is greater than the local producer index, meaning the producer index has recently been increased, the DB ringing thread may in some implementations continue by generating a ctrl segment at 612.

Generating a ctrl segment may involve creating a ctrl segment 400 as illustrated in FIG. 4 in which the value of the producer index polled at 604 is stored as a wqe_index 406. A queue number and/or an SQ number (sqn) may also or alternatively be stored in the ctrl segment as a qp_or_sq 412. In some implementations, a ctrl segment may include only a queue number and a DB may be rung by writing the queue number to a control address. In such an implementation, the queue number may prompt a peripheral device to read the producer index from memory.

In some implementations, a ctrl segment may refer to a single queue number while in other implementations, a ctrl segment may refer to multiple queue numbers. It should be appreciated that the systems and methods described herein may be used in a variety of manners to enable communication between various types of systems (such as CPUs, GPUs, DPAs, etc.) and various types of peripheral devices (such as CPUs, GPUs, DPAs, NICs, SSDs, etc.).

Because the DB ringing thread does not prepare the WQE, the DB ringing thread may first determine the queue number or sqn. Determining the queue number or sqn may involve using an array of producer indices and an array of queue numbers (or sqns). The values of the producer index array and the queue number (or sqn) array may be on a one-to-one basis. Because the DB ringing thread has access to the current producer index, the DB ringing thread can use the location of the current producer index in the producer index array to determine the location of the queue number (or sqn) in the queue number (or sqn) in the queue number (or sqn) array. Because the DB ringing thread can determine the queue number (or sqn) from the producer index, the only communication required between the requestor thread and the DB ringing thread can be the producer index.

For example, consider a system utilizing n queues. An array of producer indices (producer_idx) and an array of queue numbers may be initialized. Each of the producer_idx and queue number array may include n slots. If producer_idx [x] is updated, the DB ringing thread can determine that the updated producer_idx [x] is associated with queue number [x]. As illustrated in FIG. 4, a conventional ctrl segment 400 includes an OPC_MOD 403, a wqe_index 406, an OPODE 409, a qp_or_sq 412, and a DS 415. Using a method 600, a ctrl segment may be generated at 612 by setting the wqe_index 406 to the value of the producer index and setting the qp_or_sq 412 to the value of the queue number or sqn. Other contents of the ctrl segment, such as the OPC_MOD 403, the OPCODE 409, and the DS 415 can be set to zero. To ring the DB, the generated ctrl segment 612 can be written to a control address, or DB register, in memory of the peripheral device 304, system memory 212, or other memory which may be accessed by the peripheral device 304 as described below at 624.

In some implementations, the ctrl segment may be written to memory within the system performing the method 600 while in other implementations the ctrl segment may be written to memory of the peripheral device to be communicated with by the system performing the method 600.

In some implementations, the method 600 may also include updating the DBR 320 with the polled value of the producer index at 616.

After generating the ctrl segment at 612 and optionally updating the DBR 320 with the polled value of the producer index at 616, the DB ringing thread may perform a memory barrier at 620. As described above, a memory barrier may be used to ensure memory operations (including reads and writes) occur in the desired order. When multiple threads or processes execute concurrently, memory operations can appear out of order. A memory barrier ensures that all global and shared memory writes made by the current thread are visible to all threads in the grid and that all memory operations issued before the memory barrier are completed before any subsequent memory operations begin. Memory barriers described herein may be used to ensure any data written by a processing circuit is visible to the peripheral device.

Prior to updating the DBR 320, the current WQE data may be visible to the peripheral device 304. Upon ringing the DB 308, as described below, the peripheral device 304 will immediately read the WQE in the WQ 316. By performing a memory barrier at 620, the peripheral device 304 should read the new WQE when the DB 308 arrives at the peripheral device 304. If a memory barrier is not performed, the DB 308 may arrive at the peripheral device 304 and the peripheral device 304 may read an older WQE before the new WQE is written to the WQ 316. Performing the memory barrier at 620 may push the WQE to a cache of a GPU executing the requestor thread. The memory barrier may ensure the WQE is visible to the peripheral device 304.

It should be noted that conventional methods of ringing a DB require performing two memory barriers in sequence. A memory barrier is a time-consuming and process-intensive task. For this reason, each time a memory barrier is performed, the overall time for ringing the DB is extended. As described below, the requestor thread and the DB ringing thread of the systems and methods described herein each involve a single memory barrier. Because the requestor thread and the DB ringing thread can be executed in parallel, the overall amount of time required for memory barriers is reduced by half.

It should be appreciated that updating the DBR with the polled value of the producer index at 616 is an optional step and some implementations may be performed without updating the DBR with the polled value of the producer index at 616 and/or without the memory barrier performed at 620 as described above. In such implementations, the method 600 may involve proceeding to 624, as described below, following determining the polled producer index is greater than the local producer index at 608 and generating the ctrl segment at 612.

After the memory barrier, the DB ringing thread may ring the DB with the polled value of the producer index at 624 by writing the generated ctrl segment to a control address. The control address may be a register or other memory location within or accessible by a peripheral device such as a network adapter or other component. Ringing the DB, by writing the ctrl segment to the control address, may cause a WQE entry associated with the producer index to be read by the peripheral device.

Once the DB is rung, the peripheral device 304 may read the value of the producer index from the control address. Based on the value of the producer index, the peripheral device 304 may read data 312 from the memory of the processing unit 300. The data 312 may also be read using RDMA or a similar approach. The location of the data 312 may be obtained, at least in part, based on the value of the producer index.

Next, the peripheral device 304 may transfer the data 312 to a remote node. For instance, the peripheral device 304 may transfer the data 312 to a peer computing system 108a-d, a peer device 112, or the like.

Finally, the peripheral device 304 may notify the processing unit 300 that the operation is completed by writing to the CQ 324. RDMA may also be used to write to the CQ 324 buffer.

After ringing the DB, the DB ringing thread may set the local producer index equal to the value of the producer index polled at 628 and may return to 604 and again poll the producer index to check for another increase.

The DB ringing phase illustrated by the method 600 may run in a loop completely independent from the requestor phase illustrated by the method 500 of FIG. 5. The two phases may be executed in parallel.

The proposed solution aims at decreasing the amount of time required for ringing a DB. Instead of using a conventional method of ringing the DB by writing the entire ctrl segment to the control address, the DB ringing phase described herein can notify the peripheral device 304 with only the producer index. Advantageously, the process described in connection with FIGS. 5 and 6 may be implemented in such a way as to not require editing regkeys, resulting in an improved adoption rate as compared with conventional solutions. Moreover, by performing the requestor thread and the DB ringing thread in parallel, the amount of time required for memory barriers is decreased by half.

Aspects of the above systems and networking device include any one or more of the features as substantially disclosed herein in combination with any one or more other features as substantially disclosed herein.

Aspects of the above systems and networking device include any one of the aspects/features/embodiments in combination with any one or more other aspects/features/embodiments.

Aspects of the above systems and networking device include any use of any one or more of the aspects or features as disclosed herein.

It is to be appreciated that any feature described herein can be claimed in combination with any other feature(s) as described herein, regardless of whether the features come from the same described embodiment.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising one or more circuits to:
monitor a value of a first index;
detect a change in the value of the first index;
generate a control (ctrl) segment using at least one of the value of the first index and a queue number; and
write the ctrl segment to a control address.

2. The system of claim 1, wherein the one or more circuits further:
receive a prompt from an application;
in response to the prompt, generate a work queue entry (WQE); and
after generating the WQE, atomically increment a first counter, wherein writing the ctrl segment to the control address causes the WQE to be read by a peripheral device.

3. The system of claim 2, wherein:
one warp of a cooperative thread array (CTA):
monitors the value,
detects the change,
generates the ctrl segment, and
writes the ctrl segment to the control address; and
another warp of the CTA:
receives the prompt,
generates the WQE, and
increments the first counter.

4. The system of claim 2, wherein:
one cooperative thread array (CTA):
monitors the value,
detects the change,
generates the ctrl segment, and
writes the ctrl segment to the control address; and
another CTA:
receives the prompt,
generates the WQE, and
increments the first counter.

5. The system of claim 2, wherein the one or more circuits include:
a central processing unit (CPU) to:
monitor the value,
detect the change,
write the ctrl segment to the control address; and
a graphics processing unit (GPU) to:
receive the prompt,
generate the WQE, and
increment the first counter.

6. The system of claim 2, wherein the one or more circuits include:
a data-path accelerator (DPA) to:
monitor the value,
detect the change,
write the ctrl segment to the control address; and
a graphics processing unit (GPU) to:
receive the prompt,
generate the WQE, and
increment the first counter.

7. The system of claim 2, wherein a single thread:
monitors the value,
detects the change,
generates the ctrl segment,
writes the ctrl segment to the control address,
receives the prompt,
generates the WQE, and
increments the first counter.

8. The system of claim 2, wherein monitoring the value, detecting the change, generating the ctrl segment, and writing the ctrl segment to the control address are performed in parallel with receiving the prompt, generating the WQE, and incrementing the first counter.

9. The system of claim 2, wherein the peripheral device comprises at least one of a network interface controller (NIC), a graphical processing unit (GPU), and a solid-state drive (SSD).

10. The system of claim 1, wherein the control address is in memory of the peripheral device.

11. The system of claim 1, wherein the control address is in memory of the system.

12. The system of claim 1, wherein the ctrl segment includes data associated with a plurality of queues.

13. The system of claim 1, wherein detecting a change in the value of the first index comprises determining the value of the first index is greater than a value of a second index.

14. The system of claim 13, wherein the one or more circuits are further to set the value of the second index equal to the value of the first index after writing the ctrl segment to the control address.

15. The system of claim 1, wherein the one or more circuits are further to update a doorbell record (DBR) with the value of the first index in response to the change in the value of the first index.

16. The system of claim 1, wherein the control address is in a cache of a graphics processing unit (GPU).

17. A device, comprising one or more circuits to execute:
a first thread to:
monitor a value of a first index;
detect a change in the value of the first index;
generate a control (ctrl) segment using at least one of the value of the first index and a queue number; and
write the ctrl segment to a control address; and
a second thread to:
receive a prompt from an application;
in response to the prompt, generate a work queue entry (WQE); and
after generating the WQE, atomically increment a first counter, wherein ringing the DB causes the WQE to be read by a peripheral device.

18. The device of claim 17, wherein:
one warp of a cooperative thread array (CTA) executes the first thread; and
another warp of the CTA executes the second thread.

19. The device of claim 17, wherein:
one cooperative thread array (CTA) executes the first thread; and
another CTA executes the second thread.

20. A method of ringing a doorbell (DB), the method comprising:
monitoring a value of a first index;
detecting a change in the value of the first index;
generating a control (ctrl) segment using at least one of the value of the first index and a queue number; and
writing the ctrl segment to a control address.
